(19) United States
(12) Patent Application Publication
(10) Pub. No.: US 2007/0052628 A1
(43) Pub. Date: Mar. 8, 2007

(54) Plasma display apparatus and method of driving the same

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/516,563

(22) Filed: Sep. 7, 2006

(30) Foreign Application Priority Data
Sep. 8, 2005 (KR) 10-2005-0083644
Oct. 24, 2005 (KR) 10-2005-0100473

(51) Int. Cl. G09G 3/28

(52) U.S. Cl. 345/68

(57) ABSTRACT

A plasma display apparatus is disclosed. The plasma display apparatus includes a plasma display panel including a data electrode, and a driver. The driver raises a voltage of a data pulse supplied to the data electrode during an address period to a sum of a first voltage level higher than a ground level voltage and a second voltage level higher than the first voltage level.

This Nonprovisional application claims priority under 35 U.S.C. § 119(a) on patent application Ser. Nos. 10-2005-0083644 filed in Korea on Sep. 8, 2005 and 10-2005-0100473 filed in Korea on Oct. 24, 2005 the entire contents of which are hereby incorporated by reference.

### BACKGROUND

1. Field

This document relates to a plasma display apparatus and a method of driving the same.

2. Description of the Background Art

A plasma display panel comprises a front panel, a rear panel and barrier ribs formed between the front panel and the rear panel. The barrier ribs forms unit discharge cell or discharge cells. Each of discharge cell is filled with an inert gas containing a main discharge gas such as neon (Ne), helium (He) and a mixture of Ne and He, and a small amount of xenon (Xe). The plurality of discharge cells form one pixel. For example, a red (R) discharge cell, a green (G) discharge cell and a blue (B) discharge cell form one pixel.

When a high frequency voltage is applied to the discharge cells to generate a discharge, the inert gas generates vacuum ultra-violet rays, which thereby cause phosphors formed between the barrier ribs to emit light, thus displaying an image.

The plasma display panel comprises a plurality of electrodes, for example, a scan electrode, a sustain electrode and a data electrode. Drivers for supplying a driving voltage to each of the electrodes of the plasma display panel are connected to each of the electrodes.

When driving the plasma display panel, each of the drivers supplies a reset pulse during a reset period, a scan pulse during an address period, and a sustain pulse during a sustain period to each of the electrodes of the plasma display panel, thereby displaying an image. Since the plasma display panel can be manufactured to be thin and light, it has attracted attention as a next generation display device.

A discharge occurs by supplying the driving voltage to the plurality of electrodes, thereby displaying the image. The driver comprises a data driver and a scan driver. The data driver supplies a data pulse for selecting the discharge cell where the image to be displayed, to the data electrode during an address period. The scan driver supplies a scan pulse, synchronized with the data pulse, for selecting the discharge cell where the image to be displayed, to the scan electrode during the address period.

The data driver for driving the data electrode is weak in heat. Further, a state of a voltage supplied to the scan electrode or the data electrode changes in response to operation of a switch of a scan drive integrated circuit (IC) for driving the scan electrode and an operation of a switch of a data drive IC for driving the data electrode such that a displacement current is generated. Such a problem such as the heat or the displacement current accelerates a damage to the circuits of the scan and data drivers, and hinders an increase in a driving characteristic of the circuits.

A magnitude of the voltage supplied to the electrodes by the driver is an important factor in an operation characteristic of the driver. For example, when the data pulse supplied by the data driver during the address period has a high maximum voltage, elements with a high withstanding voltage characteristic need to be used. This results in an increase in the manufacturing cost and an increase in power consumption.

Further, the driving of the plasma display panel under the high voltage adversely affects the driver weak in heat, and increases the damage to the circuit, thereby reducing lifespan of the plasma display panel.

Further, when a voltage of the driving pulse is high, a phosphor, which is an example of a factor affecting the image quality, is greatly affected, thereby causing image sticking. This results is a reduction in the image quality.

### SUMMARY

Accordingly, an object of the present invention is to solve at least the problems and disadvantages of the background art.

In an aspect, a plasma display apparatus comprises a plasma display panel comprising a data electrode, and a driver for raising a voltage of a data pulse supplied to the data electrode during an address period to a sum of a first voltage level higher than a ground level voltage and a second voltage level higher than the first voltage level.

In another aspect, a plasma display apparatus comprises a plasma display panel comprising a data electrode, and a driver for recovering a reactive energy from the plasma display panel, and for raising a voltage of a data pulse supplied to the data electrode during an address period to a first voltage level and then to a second voltage level higher than the first voltage level stage by stage.

In still another aspect, a method of driving a plasma display apparatus comprising a data electrode comprises raising a voltage of a data pulse supplied to the data electrode during an address period to a sum of a first voltage level higher than a ground level voltage and a second voltage level higher than the first voltage level.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates an example of a plasma display apparatus;

FIG. 2 illustrates the structure of a plasma display panel of the plasma display apparatus;

FIG. 3 illustrates an example of a method for achieving gray level of an image displayed on the plasma display panel;

FIG. 4 illustrates an example of a driving waveform of the plasma display apparatus;

FIG. 5 is a block diagram of a data driver of the plasma display apparatus;

FIGS. 6a and 6b illustrate implementations of a data driver of the plasma display apparatus according to a first embodiment;

FIG. 6c illustrates an output waveform and operation timing of the data driver of each of FIGS. 6a and 6b;

FIG. 7a illustrates another implementation of the data driver of the plasma display apparatus according to the first embodiment;

FIG. 7b illustrates an output waveform and operation timing of the data driver of FIG. 7a;

FIG. 8 illustrates a data driver of a plasma display apparatus according to a second embodiment;

FIGS. 9a to 9f illustrate a circuit operation of the data driver of FIG. 8 in order;

FIG. 10 illustrates a data pulse depending on a switching operation of the data driver of FIG. 8.

### DETAILED DESCRIPTION OF PREFERRED EMBODIMENTS

Preferred embodiments of the present invention will be described in a more detailed manner with reference to the drawings.

A plasma display apparatus according to embodiments comprises a plasma display panel comprising a data electrode, and a driver for raising a voltage of a data pulse supplied to the data electrode during an address period to a sum of a first voltage level higher than a ground level voltage and a second voltage level higher than the first voltage level.

The driver may supply the first voltage level higher than the ground level voltage and then may supply the second voltage level higher than the first voltage level to the data electrode during the address period.

The driver may comprise a second voltage supply unit for supplying the second voltage to the data electrode, a voltage supply controller, formed between the second voltage supply unit and the data electrode, for controlling the supplying of the second voltage and the ground level voltage, and an energy storing unit for dividing the second voltage supplied by the second voltage supply unit and for storing the divided voltage.

The driver may comprise a driving signal output unit for outputting a voltage supplied by the second voltage supply unit and a voltage supplied by the energy storing unit to the data electrode through a predetermined switching operation of the driving signal output unit, and a ground level voltage supply unit, connected to the voltage supply controller and the energy storing unit, for supplying a ground level voltage to the data electrode.

The voltage supply controller may comprise a first switch and a second switch connected to each other in series. The energy storing unit may comprise a first energy storing unit and a second energy storing unit connected to each other in series. The second voltage supply unit may be commonly connected to one terminal of the first switch, one terminal of the first energy storing unit and one terminal of the driving signal output unit. The ground level voltage supply unit may be commonly connected to the other terminal of the first switch, one terminal of the second switch and the other terminal of the second energy storing unit. The other terminal of the driving signal output unit may be commonly connected to the other terminal of the second switch, the other terminal of the first energy storing unit and one terminal of the second energy storing unit.

When the first switch is turned on, the first voltage may be supplied to the data electrode, and the second voltage may be then supplied to the data electrode. When the second switch is turned on, the ground level voltage may be supplied to the data electrode.

When the first switch is turned on, the first voltage may be supplied to the other terminal of the driving signal output unit and the second voltage may be supplied to one terminal of the driving signal output unit.

The voltage supply controller may comprise a third switch and a fourth switch connected to each other in series. The energy storing unit may comprise a third energy storing unit and a fourth energy storing unit connected to each other in series. The second voltage supply unit may be commonly connected to one terminal of the third energy storing unit and one terminal of the driving signal output unit. The ground level voltage supply unit may be commonly connected to the other terminal of the fourth switch and the other terminal of the fourth energy storing unit. The other terminal of the driving signal output unit may be commonly connected to the other terminal of the third switch and one terminal of the fourth switch.

When the third switch is turned on, the first voltage may be supplied to the data electrode, and the second voltage may be then supplied to the data electrode. When the fourth switch is turned on, the ground level voltage may be supplied to the data electrode.

When the third switch is turned on, the first voltage may be supplied to the other terminal of the driving signal output unit and the second voltage may be supplied to one terminal of the driving signal output unit.

The driver may comprise a first voltage supply unit for supplying the first voltage to the data electrode, a second voltage supply unit for supplying the second voltage to the data electrode, and a voltage supply controller, formed between the first voltage supply unit and the second voltage supply unit, for controlling the supplying of the first voltage, the second voltage and the ground level voltage.

The driver may comprise a driving signal output unit for outputting a voltage supplied by the first voltage supply unit and a voltage supplied by the second voltage supply unit to the data electrode through a predetermined switching operation of the driving signal output unit, and a ground level voltage supply unit, connected to the voltage supply controller, for supplying the ground level voltage to the data electrode.

The voltage supply controller may comprise a fifth switch, a sixth switch and a seventh switch connected to one another in series. The second voltage supply unit may be commonly connected to one terminal of the fifth switch and one terminal of the driving signal output unit. The ground level voltage supply unit may be commonly connected to the other terminal of the fifth switch and one terminal of the sixth switch. The other terminal of the driving signal output unit may be commonly connected to the other terminal of the sixth switch and one terminal of the seventh switch. The first voltage supply unit may be connected to the other terminal of the seventh switch.

When the fifth switch and the seventh switch are turned on, the first voltage may be supplied to the data electrode, and the second voltage may be then supplied to the data electrode. When the sixth switch is turned on, the ground level voltage may be supplied to the data electrode.

When the fifth switch and the seventh switch are turned on, the first voltage may be supplied to the other terminal of the driving signal output unit, and the second voltage may be supplied to one terminal of the driving signal output unit.

A plasma display apparatus according to the embodiments comprises a plasma display panel comprising a data electrode, and a driver for recovering a reactive energy from the plasma display panel, and for raising a voltage of a data pulse supplied to the data electrode during an address period to a first voltage level and then to a second voltage level higher than the first voltage level stage by stage.

The driver may comprise an energy storing unit for storing the reactive energy recovered from the plasma display panel, a first energy supply/recovery controller for supplying a portion of the energy stored in the energy storing unit to the data electrode through resonance, a first voltage supply unit for maintaining a voltage of the data electrode at a first voltage level, a second energy supply/recovery controller for supplying the energy stored in the energy storing unit to the data electrode through resonance during the supplying of the first voltage, and a second voltage supply unit for maintaining a voltage of the data electrode at a second voltage level during the supplying of the first voltage.

The driver may comprise a driving signal output unit for outputting voltages supplied by the first voltage supply unit or the second voltage supply unit to the data electrode through a predetermined switching operation of the driving signal output unit, and a ground level voltage supply unit for maintaining a voltage of the data electrode at a ground level voltage.

The energy storing unit may comprise a first energy storing unit, a second energy storing unit, and a third energy storing unit. The first voltage supply unit may comprise a first voltage source and a first switch for controlling the supplying of the first voltage by the first voltage source. One terminal of the first energy storing unit may be commonly connected to one terminal of the first energy supply/recovery controller and the other terminal of the second energy storing unit, and the other terminal of the first energy storing unit may be connected to a ground level voltage source. The other terminal of the first energy supply/recovery controller may be commonly connected to the other terminal of the first switch, the other terminal of the ground level voltage supply unit and the other terminal of the driving signal output unit. One terminal of the first switch may be commonly connected to one terminal of the first voltage source, one terminal of the second energy storing unit and the other terminal of the third energy storing unit. One terminal of the third energy storing unit may be connected to one terminal of the second energy supply/recovery controller. The other terminal of the second energy supply/recovery controller may be commonly connected to the second voltage supply unit and one terminal of the driving signal output unit.

When a switch of the first energy supply/recovery controller is turned on, an energy may be supplied to the data electrode, and when the first switch of the first voltage supply unit is turned on, the first voltage is supplied to the data electrode. When a switch of the second energy supply/recovery controller is turned on, an energy may be supplied to the data electrode, and when a switch of the second voltage supply unit is turned on, a voltage of the data electrode is maintained at the second voltage level.

The first voltage may be supplied to the other terminal of the driving signal output unit, and the second voltage may be supplied to one terminal of the driving signal output unit.

A method of driving a plasma display apparatus comprising a data electrode according to the embodiments, the method comprises raising a voltage of a data pulse supplied to the data electrode during an address period to a sum of a first voltage level higher than a ground level voltage and a second voltage level higher than the first voltage level.

A reactive energy may be recovered from the plasma display apparatus such that the data pulse may be supplied to the data electrode using the recovered energy.

The method may further comprises storing the reactive energy recovered from the plasma display apparatus, supplying an energy stored in an energy storing unit to the data electrode through resonance during the address period to raise a voltage of the data electrode to a first voltage level, maintaining a voltage of the data electrode at the first voltage level during the address period, supplying the energy stored in the energy storing unit to the data electrode through resonance during the supplying of the first voltage in the address period to raise a voltage of the data electrode to a second voltage level, and maintaining a voltage of the data electrode at the second voltage level during the supplying of the first voltage in the address period.

Hereinafter, exemplary implementations will be described in detail with reference to the attached drawings.

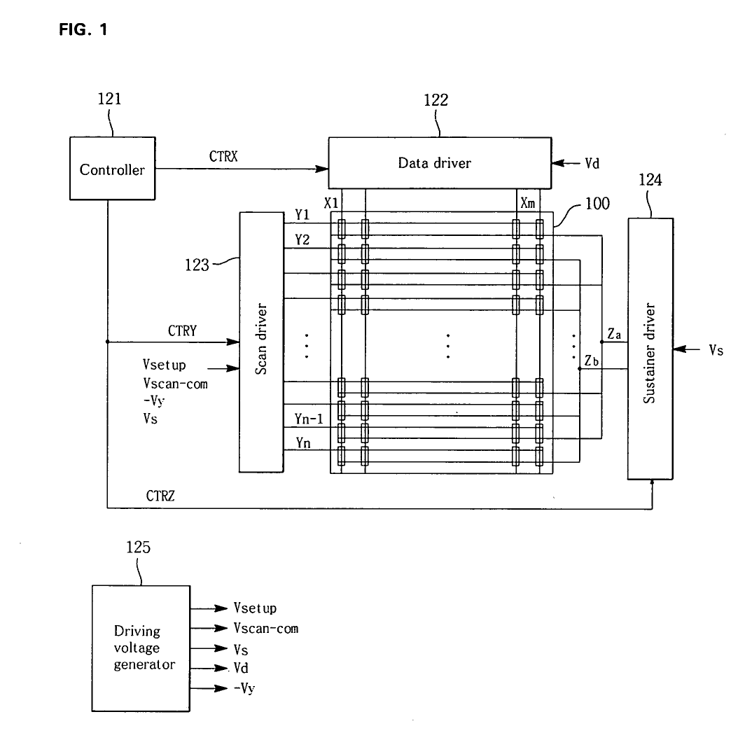

FIG. 1 illustrates an example of a plasma display apparatus.

As illustrated in FIG. 1, the plasma display apparatus comprises a plasma display panel 100 on which an image is displayed by processing image data input from the outside, a driver for supplying a driving pulse to electrodes of the plasma display panel 100, a controller 121 and a driving voltage generator 125. The driver includes a data driver 122 for supplying data to data electrodes X1 to Xm, a scan driver 123 for driving scan electrodes Y1 to Yn, and a sustain driver 124 for driving sustain electrodes Z being common electrodes. The controller 121 controls the data driver 122, the scan driver 123 and the sustain driver 124 when driving the plasma display panel 100. The driving voltage generator 125 supplies a necessary driving voltage to each of the drivers 122, 123 and 124.

The plasma display panel 100 comprises a front substrate (not illustrated) and a rear substrate (not illustrated) which are coalesced with each other at a given distance. On the front substrate, a plurality of electrodes, for example, the scan electrodes Y1 to Yn and the sustain electrodes Z are formed in pairs. On the rear substrate, the data electrodes X1 to Xm are formed to intersect the scan electrodes Y1 to Yn and the sustain electrodes Z.

The data driver 122 receives data mapped for each subfield by a subfield mapping circuit (not illustrated) after being inverse-gamma corrected and error-diffused through an inverse gamma correction circuit (not illustrated) and an error diffusion circuit (not illustrated), or the like. The data driver 122, under the control of the controller 121, samples and latches the mapped data, and then supplies a data pulse in accordance with the data to the data electrodes X1 to Xm.

The data driver 122 raises the voltage of the data pulse supplied to the data electrode during the address period to a sum of a first voltage level higher than a ground level voltage and a second voltage level higher than the first voltage level.

The scan driver 123, under the control of the controller 121, supplies a reset pulse to the scan electrodes Y1 to Yn during a reset period to initialize discharge cells corresponding to the whole screen. Further, the scan driver 123 supplies a scan reference voltage Vsc during an address period after supplying the reset pulse, and then a scan pulse falling from the scan reference voltage Vsc to a negative voltage level to the scan electrodes Y1 to Yn, thereby scanning scan electrode lines.

The scan driver 123 supplies a sustain pulse to the scan electrodes Y1 to Yn during a sustain period to generate a sustain discharge in a discharge cell selected during the address period.

The sustain driver 124, under the control of the controller 121, supplies a sustain pulse to the sustain electrodes Z during the sustain period. The scan driver 123 and the sustain driver 124 alternately operates to supply the sustain pulse.

The controller 121 receives a vertical/horizontal synchronization signal, and generates timing control signals CTRX, CTRY and CTRZ required in each driver 122, 123 and 124. The controller 121 supplies the timing control signals CTRX, CTRY and CTRZ to the corresponding drivers 122, 123 and 124 to control each of the drivers 122, 123 and 124. The timing control signal CTRX applied to the data driver 122 includes a sampling clock for sampling data, a latch control signal, and a switch control signal for controlling on/off time of an energy recovery circuit and a driving switch element.

The timing control signal CTRY applied to the scan driver 123 includes a switch control signal for controlling on/off time of an energy recovery circuit and a driving switch element inside the scan driver 123. The timing control signal CTRZ applied to the sustain driver 124 includes a switch control signal for controlling on/off time of an energy recovery circuit and a driving switch element inside the sustain driver 124.

The driving voltage generator 125 generates various driving voltages required in each driver 122, 123 and 124, for example, a sustain voltage Vs, a scan reference voltage Vsc, a data voltage Va, a scan voltage −Vy. These driving voltages may vary in accordance with the composition of the discharge gas or the structure of the discharge cells.

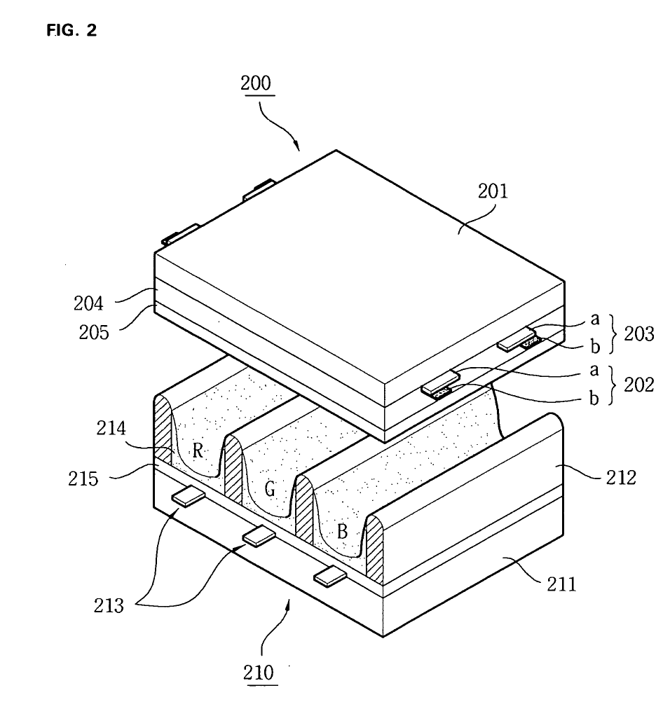

FIG. 2 illustrates the structure of a plasma display panel of the plasma display apparatus.

As illustrated in FIG. 2, the plasma display panel comprises a front panel 200 and a rear panel 210 which are coupled in parallel to oppose to each other at a given distance therebetween. The front panel 200 comprises a front substrate 201 which is a display surface. The rear panel 210 comprises a rear substrate 211 constituting a rear surface. A plurality of scan electrodes 202 and a plurality of sustain electrodes 203 are formed in pairs on the front substrate 201, on which an image is displayed, to form a plurality of maintenance electrode pairs. A plurality of data electrodes 213 are arranged on the rear substrate 211 to intersect with the plurality of maintenance electrode pairs.

The scan electrode 202 and the sustain electrode 203 each comprise transparent electrodes 202a and 203a made of a transparent indium-tin-oxide (ITO) material and bus electrodes 202b and 203b made of a metal material. The scan electrode 202 and the sustain electrode 203 generate a mutual discharge therebetween in one discharge cell and maintain light-emissions of discharge cells. The scan electrode 202 and the sustain electrode 203 each may comprise either the transparent electrodes 202a and 203a or the bus electrodes 202b and 203b. The scan electrode 202 and the sustain electrode 203 are covered with one or more upper dielectric layers 204 to limit a discharge current and to provide insulation between the maintenance electrode pairs. A protective layer 205 with a deposit of MgO is formed on an upper surface of the upper dielectric layer 204 to facilitate discharge conditions.

A plurality of well-type barrier ribs are formed on the rear substrate 211 of the rear panel 210 to form a plurality of discharge spaces, i.e., a plurality of discharge cells. The plurality of well-type barrier ribs comprise a transverse barrier rib (not illustrated) and a longitudinal barrier rib 212. The plurality of data electrodes 213 for performing an address discharge to generate vacuum ultraviolet rays are arranged in parallel to the longitudinal barrier rib 212.

An upper surface of the rear substrate 211 is coated with Red (R), green (G) and blue (B) phosphors 214 for emitting visible light for an image display when the address discharge is performed. A lower dielectric layer 215 is formed between the data electrodes 213 and the phosphors 214 to protect the data electrodes 213.

The front panel 200 and the rear panel 210 thus formed are coalesced by a sealing process such that the plasma display panel is completed. The drivers for driving the scan electrode 202, the sustain electrode 203 and the data electrode 213 are adhered to the plasma display panel to complete the plasma display apparatus.

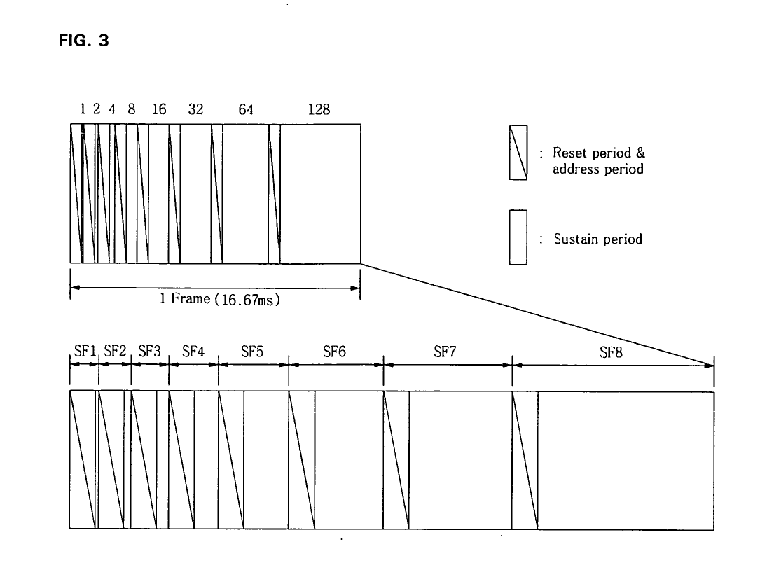

FIG. 3 illustrates an example of a method for achieving gray level of an image displayed on the plasma display panel.

As illustrated in FIG. 3, the plasma display panel is driven by dividing a frame into several subfields. Each of the subfields is subdivided into a reset period for initializing all the cells, an address period for selecting cells to be discharged, and a sustain period for representing gray scale in accordance with the number of discharges.

For example, if an image with 256-level gray scale is to be displayed, a frame period (for example, 16.67 ms) corresponding to 1/60 sec is divided into eight subfields SF1 to SF8. Each of the eight subfields SF1 to SF8 is subdivided into a reset period, an address period and a sustain period. A duration of the reset period in a subfield is equal to a duration of the reset periods in the remaining subfields. A duration of the address period in a subfield is equal to a duration of the address periods in the remaining subfields. However, a duration of the sustain period of each subfield may be different from one another, and the number sustain pulses assigned during the sustain period of each subfield may be different from one another. For example, the sustain period increases in a ratio of 2ⁿ (where, n=0, 1, 2, 3, 4, 5, 6, 7) in each of the subfields such that gray level of an image can be represented.

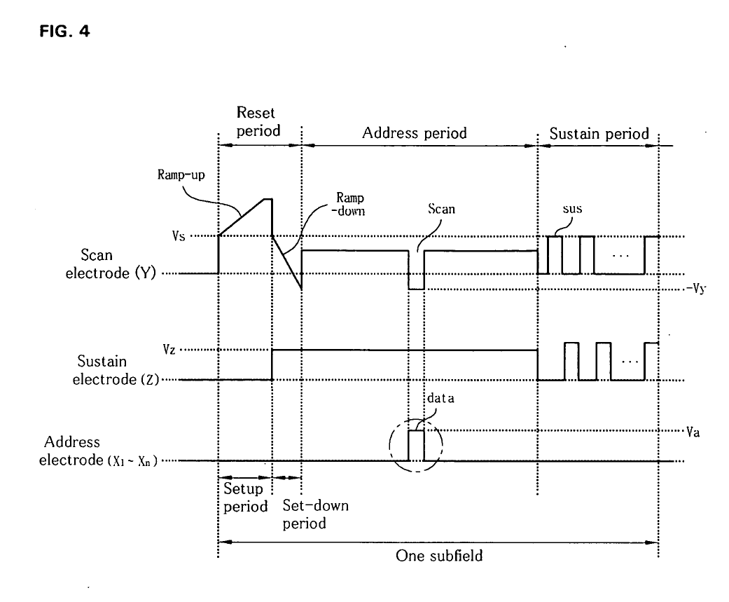

FIG. 4 illustrates an example of a driving waveform of the plasma display apparatus.

As illustrated in FIG. 4, the plasma display apparatus is driven by dividing each subfield into a reset period for initializing all the cells, an address period for selecting cells to be discharged, and a sustain period for holding the selected cells in a discharge state.

The reset period is further divided into a setup period and a set-down period. During the setup period, a rising pulse (Ramp-up) with a high voltage is simultaneously supplied to all the scan electrodes Y. The rising pulse (Ramp-up) generates a weak discharge (i.e., a setup discharge) within the discharge cells of the whole screen, thereby producing wall charges within the discharge cells.

During the set-down period, a falling pulse (Ramp-down) is simultaneously supplied to the scan electrodes Y, thereby causing a weak erase discharge within the discharge cells. Accordingly, the wall charges within the discharge cells excessively accumulated by performing the setup discharge remain uniform.

During the address period, a scan pulse (Scan) with a scan voltage −Vy is sequentially supplied to the scan electrodes Y and, at the same time, a data pulse (data) is selectively applied to the data electrodes X. As a voltage difference between the scan pulse (Scan) and the data pulse (data) is added to a wall voltage produced during the reset period, an address discharge occurs within the discharge cells to which the data pulse (data) is supplied. Wall charges are produced inside the discharge cells selected by performing the address discharge.

A positive voltage Vz is supplied to the sustain electrode Z during the set-down period and the address period so that an erroneous discharge does not occur between the sustain electrode Z and the scan electrode Y.

During the sustain period, a sustain pulse (sus) is alternately supplied to the scan electrode Y and the sustain electrode Z, thereby generating a sustain discharge.

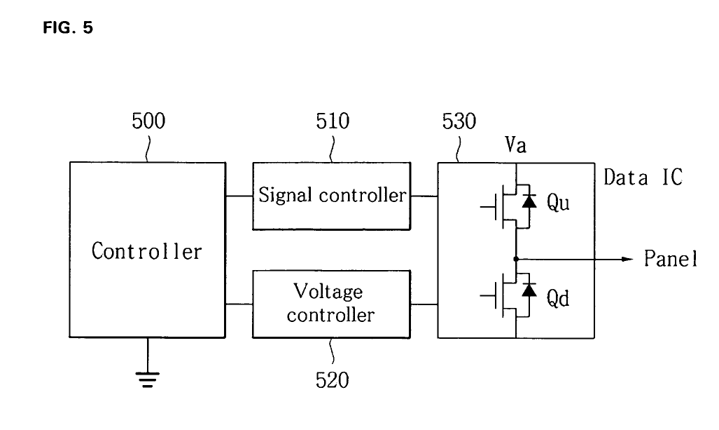

FIG. 5 is a block diagram of a data driver of the plasma display apparatus.

As illustrated in FIG. 5, the data driver comprises a controller 500, a driving signal output unit 530, a signal controller 510 and a voltage controller 520. The controller 500 supplies a control signal to the data electrode of the plasma display panel. The driving signal output unit 530 comprising a data electrode driving IC turns on/off switches Qu and Qd in response to the control signal supplied from controller 500 to control a pulse outputted to the data electrode of the plasma display panel. The signal controller 510 and the voltage controller 520 may vary a reference voltage of the data electrode driving IC during a portion of the address period when a pulse for data entry is supplied.

The signal controller 510 and the voltage controller 520 vary the reference voltage of the data electrode driving IC between a ground level voltage and a voltage higher than the ground level voltage such that when switches of the data electrode driving IC operate, a swing width of the pulse for the data entry decreases. For example, the signal controller 510 and the voltage controller 520 raises the voltage of the data pulse supplied to the data electrode during the address period to a sum of a first voltage level higher than a ground level voltage and a second voltage level higher than the first voltage level. More specifically, the first voltage level higher than the ground level voltage and then the second voltage level higher than the first voltage level are supplied to the data electrode, thereby completing the supplying of the data pulse. The reference voltage supplied to the data electrode driving IC is higher than the ground level voltage and is lower than a driving voltage Va of the data electrode. As the reference voltage supplied to the data electrode, by supplying a voltage Va/2 corresponding to one half the driving voltage Va or a predetermined voltage Vam, the swing width (i.e., a voltage change in the pulse for the data entry) of a switch installed inside the data electrode driving IC decreases from 0-Va to Va/2-Va. In other words, a voltage difference between both terminals of the data driver decreases such that the data driver can be driven at a low voltage, thereby stabilizing the operation of the data driver.

The signal controller 510 supplies a pulse capable of varying the reference voltage of the driving signal output unit 530 to the driving signal output unit 530. The voltage controller 520 controls an output of the pulse which the signal controller 510 supplies to the signal controller 510.

Various implementations of the data driver will be described in detail below.

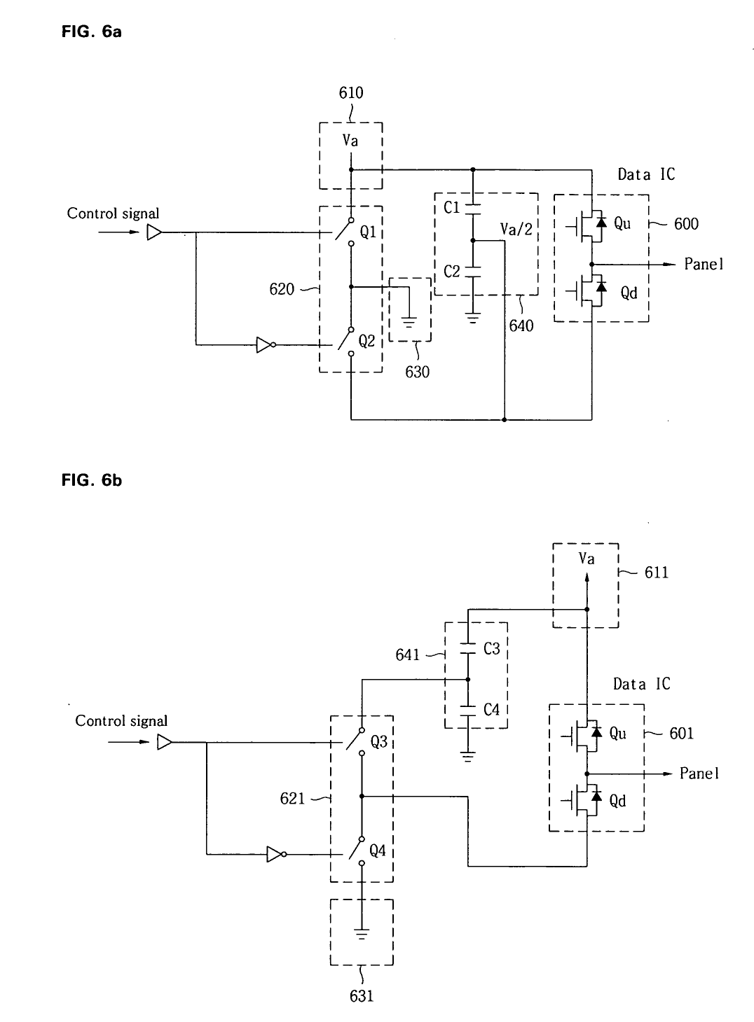

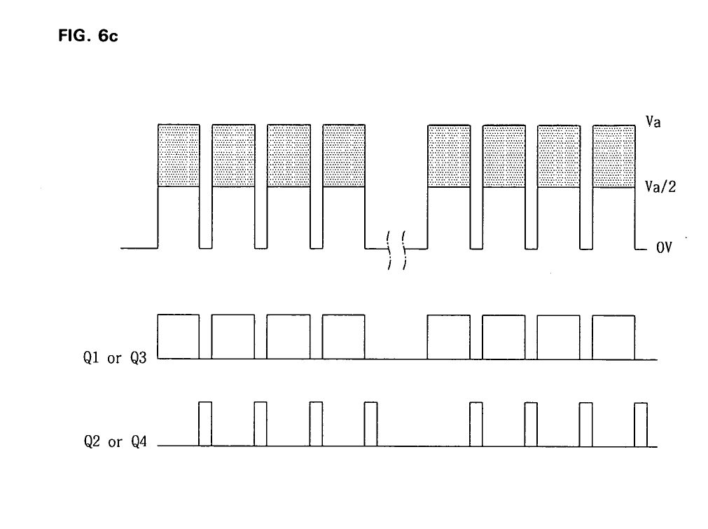

FIG. 6a illustrates a data driver of a plasma display apparatus according to a first embodiment.

As illustrated in FIG. 6a, the data driver may comprise a second voltage supply unit 610, a voltage supply controller 620 and an energy storing unit 640. The data driver may further comprise a ground level voltage supply unit 630 and a driving signal output unit 600.

The second voltage supply unit 610 supplies the second voltage, for example, the data voltage Va to the data electrode.

The voltage supply controller 620 is formed between the second voltage supply unit 610 and the data electrode, and controls the supplying of the second voltage and the ground level voltage. The voltage supply controller 620 may comprise a first switch Q1 and a second switch Q2 connected to each other in series.

The energy storing unit 640 divides the second voltage supplied by the second voltage supply unit 610 and stores the divided voltage. The energy storing unit 640 may store a voltage, that is higher than the ground level voltage and is lower than the second voltage level Va, for example, the voltage Va/2 corresponding to one half the second voltage level Va. The energy storing unit 640 may comprise a first energy storing unit C1 and a second energy storing unit C2 connected to each other in series.

The driving signal output unit 600 outputs a voltage supplied by the second voltage supply unit 610 and a voltage supplied by the energy storing unit 640 to the data electrode through a predetermined switching operation of the driving signal output unit 600.

The ground level voltage supply unit 630 is connected to the voltage supply controller 620 and the energy storing unit 640, and supplies the ground level voltage to the data electrode.

The second voltage supply unit 610 is commonly connected to one terminal of the first switch Q1, one terminal of the first energy storing unit C1 and one terminal of the driving signal output unit 600. The ground level voltage supply unit 630 is commonly connected to the other terminal of the first switch Q1, one terminal of the second switch Q2 and the other terminal of the second energy storing unit C2. The other terminal of the driving signal output unit 600 is commonly connected to the other terminal of the second switch Q2, the other terminal of the first energy storing unit C1 and one terminal of the second energy storing unit C2.

When the first switch Q1 is turned on, the first voltage, for example, one half (Va/2) the second voltage (i.e., the data voltage) is supplied to the data electrode, and the second voltage is then supplied to the data electrode. Next, when the second switch Q2 is turned on, the ground level voltage is supplied to the data electrode.

When the first switch Q1 is turned on, the second voltage is supplied to one terminal (i.e., a switch Qu) of the driving signal output unit 600, and the first voltage is supplied to the other terminal (i.e., a switch Qd) of the driving signal output unit 600. Accordingly, a difference between the voltages supplied to both switches of the driving signal output unit 600 decreases by the voltage Va/2. In such a case, since the driving signal output unit 600 can be driven at a voltage (voltage Va/2) lower than the existing voltage (i.e., voltage Va), power consumption in the data driver illustrated in FIG. 6a is equal to one quarter of power consumption in the existing circuit, thereby improving the driving efficiency. Further, a current flowing in the driving signal output unit 600 (i.e., the data electrode driving IC) may decrease to approximately one half of a current flowing in the existing circuit such that a problem of heat generation is solved without a heat sink. The data driver of FIG. 6a is driven at a low voltage and a low power, thereby protecting the elements of the data driver. Further, the data driver of FIG. 6a may comprise the elements with a low withstanding voltage characteristic, thereby reducing the manufacturing cost.

FIG. 6b illustrates another data driver of the plasma display apparatus according to the first embodiment.

As illustrated in FIG. 6b, the data driver may comprise a second voltage supply unit 611, a voltage supply controller 621 and an energy storing unit 641. The data driver may further comprise a ground level voltage supply unit 631 and a driving signal output unit 601.

The second voltage supply unit 611 supplies the second voltage, for example, the data voltage Va to the data electrode.

The voltage supply controller 621 is formed between the second voltage supply unit 611 and the data electrode, and controls the supplying of the second voltage and the ground level voltage. The voltage supply controller 621 may comprise a third switch Q3 and a fourth switch Q4 connected to each other in series.

The energy storing unit 641 divides the second voltage supplied by the second voltage supply unit 611 and stores the divided voltage. The energy storing unit 641 may store a voltage, that is higher than the ground level voltage and is lower than the second voltage level Va, for example, the voltage Va/2 corresponding to one half the second voltage level Va. The energy storing unit 641 may comprise a third energy storing unit C3 and a fourth energy storing unit C4 connected to each other in series.

The driving signal output unit 601 outputs a voltage supplied by the second voltage supply unit 611 and a voltage supplied by the energy storing unit 641 to the data electrode through a predetermined switching operation of the driving signal output unit 601.

The ground level voltage supply unit 631 is connected to the voltage supply controller 621 and the energy storing unit 641, and supplies the ground level voltage to the data electrode.

The second voltage supply unit 611 is commonly connected to one terminal of the third energy storing unit C3 and one terminal of the driving signal output unit 601. The ground level voltage supply unit 631 is commonly connected to the other terminal of the fourth switch Q4 and the other terminal of the fourth energy storing unit C4. The other terminal of the driving signal output unit 601 is commonly connected to the other terminal of the third switch Q3 and one terminal of the fourth switch Q4.

When the third switch Q3 is turned on, the first voltage, for example, one half (Va/2) the second voltage (i.e., the data voltage) is supplied to the data electrode, and the second voltage is then supplied to the data electrode. Next, when the fourth switch Q4 is turned on, the ground level voltage is supplied to the data electrode.

When the third switch Q3 is turned on, the second voltage is supplied to one terminal (i.e., a switch Qu) of the driving signal output unit 601, and the first voltage is supplied to the other terminal (i.e., a switch Qd) of the driving signal output unit 601. Accordingly, a difference between the voltages supplied to both switches of the driving signal output unit 601 decreases by the voltage Va/2.

The data driver of FIG. 6b is driven at a low voltage and a low power, thereby reducing power consumption and protecting the elements of the data driver. Further, the data driver of FIG. 6b stabilizes its circuit operation.

FIG. 6c illustrates an output waveform and operation timing of the data driver of each of FIGS. 6a and 6b.

As illustrated in FIG. 6c, when the first switch Q1 of FIG. 6a or the third switch Q3 of FIG. 6b is turned on, the first voltage, for example, one half (Va/2) the second voltage level (i.e., the data voltage) is supplied to the data electrode, and the second voltage is then supplied to the data electrode. In other words, the data pulse raises the voltage of the data pulse to a sum of the first voltage Va/2 and the second voltage level Va. Afterwards, when the second switch Q2 of FIG. 6a or the fourth switch Q4 of FIG. 6b is turned on, the ground level voltage is supplied to the data electrode.

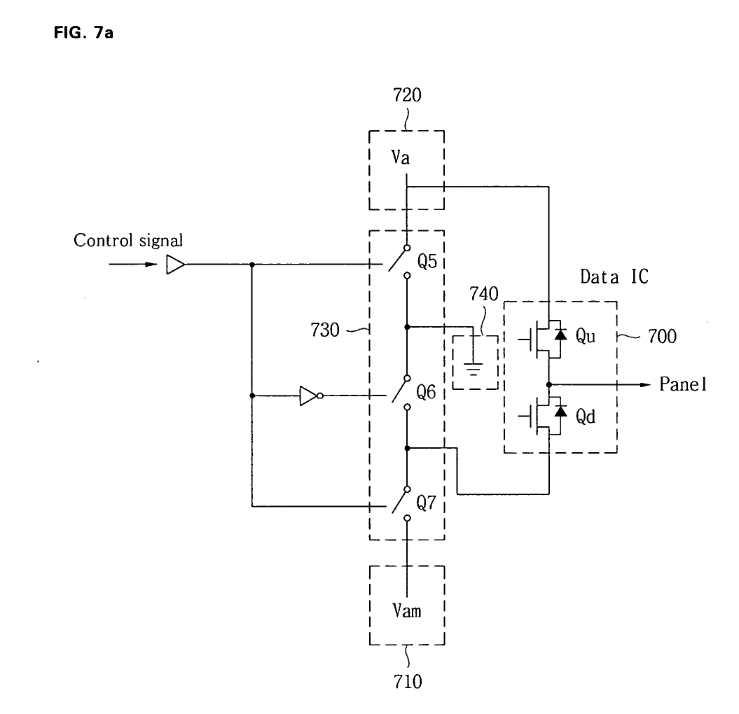

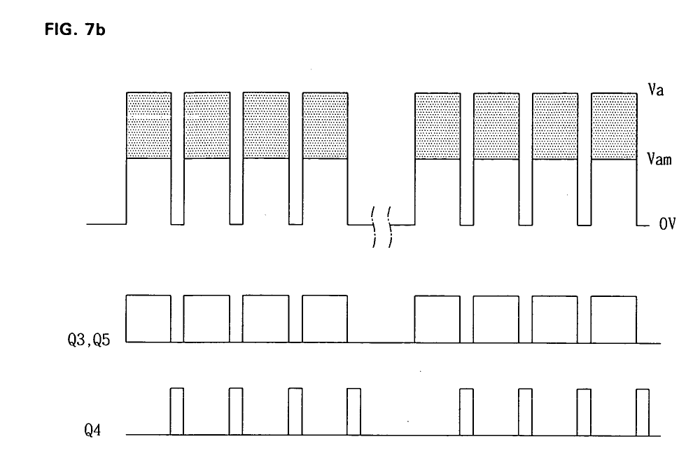

FIG. 7 illustrates still another data driver of the plasma display apparatus according to the first embodiment.

As illustrated in FIG. 7, the data driver may comprise a first voltage supply unit 710, a second voltage supply unit 720 and a voltage supply controller 730. The data driver may further comprise a ground level voltage supply unit 740 and a driving signal output unit 700.

The first voltage supply unit 710 supplies a first voltage Vam to the data electrode.

The second voltage supply unit 720 supplies the second voltage, for example, the data voltage Va to the data electrode.

The voltage supply controller 730 is formed between the first voltage supply unit 710 and the second voltage supply unit 611, and controls the supplying of the first voltage, the second voltage and the ground level voltage. The voltage supply controller 730 may comprise a fifth switch Q5, a sixth switch Q6 and a seventh switch Q7 connected to one another in series.

The driving signal output unit 700 outputs a voltage supplied by the first voltage supply unit 710 and a voltage supplied by the second voltage supply unit 720 to the data electrode through a predetermined switching operation of the driving signal output unit 700.

The ground level voltage supply unit 740 is connected to the voltage supply controller 730, and supplies the ground level voltage to the data electrode.

The second voltage supply unit 720 is commonly connected to one terminal of the fifth switch Q5 and one terminal of the driving signal output unit 700. The ground level voltage supply unit 740 is commonly connected to the other terminal of the fifth switch Q5 and one terminal of the sixth switch Q6. The other terminal of the driving signal output unit 700 is commonly connected to the other terminal of the sixth switch Q6 and one terminal of the seventh switch Q7. The first voltage supply unit 710 is commonly connected to the other terminal of the seventh switch Q7.

When the fifth switch Q5 and the seventh switch Q7 are turned on, the first voltage supply unit 710 supplies the first voltage Vam to the data electrode, and the second voltage supply unit 720 supplies the second voltage Va (i.e., the data voltage) to the data electrode. Afterwards, when the sixth switch Q6 is turned on, the ground level voltage is supplied to the data electrode.

When the fifth switch Q5 and the seventh switch Q7 are turned on, the second voltage Va is supplied to one terminal (i.e., a switch Qu) of the driving signal output unit 700, and the first voltage Vam is supplied to the other terminal (i.e., a switch Qd) of the driving signal output unit 700. Accordingly, a difference between the voltages supplied to both switches of the driving signal output unit 700 decreases to the voltage (Va-Vam). In other words, the data driver of FIG. 7a can be driven at a low voltage, thereby improving a driving characteristic.

FIG. 7b illustrates an output waveform and operation timing of the data driver of each of FIG. 7a.

As illustrated in FIG. 7b, when the fifth switch Q5 and the seventh switch Q7 are turned on, a predetermined voltage (i.e., the first voltage level Vam) that is higher than the ground level voltage and is lower than the data voltage is supplied to the data electrode, and the second voltage is then supplied to the data electrode. In other words, the data pulse rises to a sum of the first voltage level Vam and the second voltage level Va. Afterwards, when the sixth switch Q6 is turned on, the ground level voltage is supplied to the data electrode.

As described above, since the data driver supplies the data pulse to the data electrode through stage by stage, the difference between the voltages supplied to both terminals of the circuit element of the data driver decreases. Accordingly, the data driver can be stably driven at the low voltage. This results in an improvement of the reliability of the circuit operation of the data driver and a reduction in the manufacturing cost.

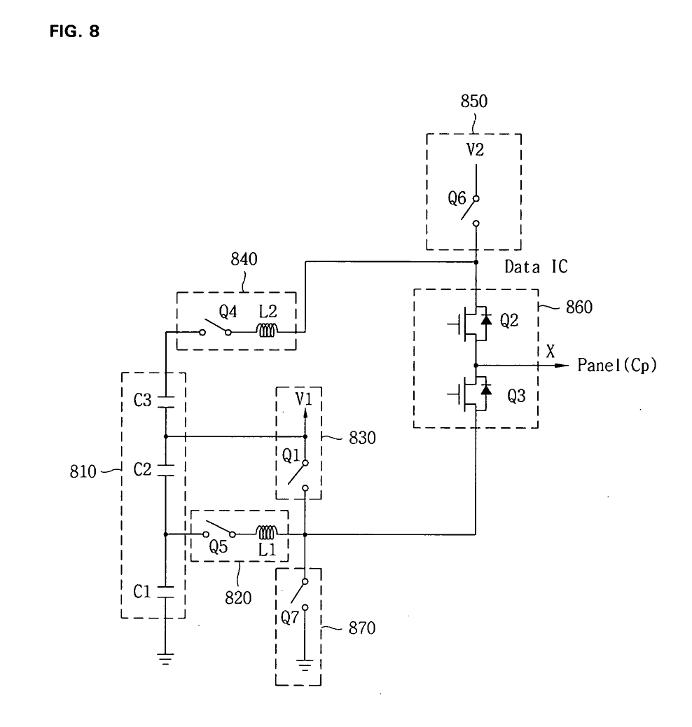

Furthermore, power consumption can be minimized and the driving efficiency can be improved by recovering a reactive voltage of the plasma display apparatus and supplying the data pulse using the recovered voltage. This will be described in detail with reference to FIG. 8.

FIG. 8 illustrates a data driver of a plasma display apparatus according to a second embodiment.

The data driver illustrated in FIG. 8 raises the voltage of a data pulse supplied to the data electrode during an address period using a reactive energy recovered from the plasma display panel to a first voltage level and then to a second voltage level higher than the first voltage level stage by stage.

The data driver comprises an energy storing unit 810, a first energy supply/recovery controller 820, a first voltage supply unit 830, a second energy supply/recovery controller 840, and a second voltage supply unit 850. Further, the data driver further may comprise a driving signal output unit 860 and a ground level voltage supply unit 870.

The energy storing unit 810 comprises an energy supply/recovery capacitor for storing the reactive energy recovered from the plasma display panel in the supplying of the data pulse for performing an address discharge, and for supplying the stored energy to the data electrode. The energy supply/recovery capacitor may comprise a first energy storing unit C1, a second energy storing unit C2, and a third energy storing unit C3.

The first energy supply/recovery controller 820 supplies a portion of the energy stored in the energy storing unit 810 to the data electrode through LC resonance. The first energy supply/recovery controller 820 comprises a first inductor L1 and a fifth switch Q5 for controlling the supplying of the energy stored in the energy storing unit 810. The first inductor L1 and the plasma display panel form the LC resonance. One terminal of the fifth switch Q5 is commonly connected to one terminal of the first energy storing unit C1 and the other terminal of the second energy storing unit C2, and the other terminal of the fifth switch Q5 is connected to one terminal of the first inductor L1. The other terminal of the first inductor L1 is commonly connected to the other terminal of a first switch Q1 of the first voltage supply unit 830, one terminal of a seventh switch Q7 of the ground level voltage supply unit 870, and the other terminal of a third switch Q3 of the driving signal output unit 860. The first energy supply/recovery controller 820 controls the supplying of the energy stored in the energy storing units to the data electrode through the LC between the plasma display panel and the first inductor L1, when rising the data pulse to the first voltage level.

The first voltage supply unit 830 comprises a first voltage source (not illustrated) for supplying the first voltage V1 and a first switch Q1 for controlling the supplying of the first voltage V1. One terminal of the first switch Q1 is commonly connected to one terminal of the first voltage source, one terminal of the second energy storing unit C2 and the other terminal of the third energy storing unit C3. The other terminal of the first switch Q1 is connected to the other terminal of the first inductor L1, one terminal of the seventh switch Q7 and the third switch Q3 of the driving signal output unit 860. The first voltage supply unit 830 maintains a voltage of the data electrode at the first voltage level V1 during the address period. In other words, after the first energy supply/recovery controller 820 supplies the reactive energy of the plasma display panel stored in the energy storing unit 840 to the data electrode, the first voltage supply unit 830 supplies the first voltage to the data electrode such that the voltage of the data electrode is maintained at the first voltage level V1.

The second energy supply/recovery controller 840 supplies the energy stored in the energy storing unit 810 to the data electrode through LC resonance. The second energy supply/recovery controller 840 comprises a second inductor L2 and a fourth switch Q4 for controlling the supplying of the energy stored in the energy storing unit 810. The second inductor L2 and the plasma display panel form the LC resonance. One terminal of the fourth switch Q4 is connected to one terminal of the third energy storing unit C3, and the other terminal of the fourth switch Q4 is connected to one terminal of the second inductor L2. The other terminal of the second inductor L2 is commonly connected to the other terminal of a sixth switch Q6 of the second voltage supply unit 850 and one terminal of a second switch Q2 of the driving signal output unit 860. The second energy supply/recovery controller 840 controls the supplying of the energy stored in the energy storing units to the data electrode through the LC between the plasma display panel and the second inductor L2, when rising the data pulse from the first voltage level to the second voltage level.

The second voltage supply unit 850 comprises a second voltage source (not illustrated) for supplying the second voltage V2 and the sixth switch Q6 for controlling the supplying of the second voltage V2. One terminal of the sixth switch Q6 is connected to one terminal of the second voltage source, and the other terminal of the second switch Q2 is connected to the other terminal of the second inductor L2 and one terminal of the second switch Q2 of the driving signal output unit 860. The second voltage supply unit 850 maintains a voltage of the data electrode at the second voltage level during the address period. In other words, after the second energy supply/recovery controller 840 supplies the reactive energy of the plasma display panel stored in the energy storing units C1, C2 and C3 to the data electrode, the second voltage supply unit 850 supplies the second voltage to the data electrode.

The driving signal output unit 860 comprises the second switch Q2 and the third switch Q3 connected to each other in series in a push-pull form. The data electrode is connected between the other terminal of the second switch Q2 and one terminal of the third switch Q3. One terminal of the second switch Q2 is commonly connected to the other terminal of the sixth switch Q6 of the second voltage supply unit 850 and the other terminal of the second inductor L2 of the second energy supply/recovery circuit unit 840. The other terminal of the third switch Q3 is commonly connected to the other terminal of the first switch Q1 of the first voltage supply unit 830, the other terminal of the first inductor L1 of the first energy supply/recovery controller 820, and the ground level voltage supply unit 870. The driving signal output unit 860 outputs the voltages, which the first energy supply/recovery controller 820, the first voltage supply unit 830, the second energy supply/recovery circuit unit 840 and the second voltage supply unit 850 each supply, to the data electrode through a predetermined switching operation of the driving signal output unit 860.

The ground level voltage supply unit 870 comprises the seventh switch Q7 for controlling a ground level voltage source and the supplying oh the ground level voltage. The other terminal of the seventh switch Q7 is connected to the ground level voltage source, and one terminal of the seventh switch Q7 is commonly connected to the other terminal of the first switch Q1 of the first voltage supply unit 830, the other terminal of the first inductor L1 of the first energy supply/recovery controller 820, and the other terminal of the third switch Q3 of the driving signal output 860 such that the ground level voltage supply unit 870 maintains the voltage of the data electrode at the ground level voltage.

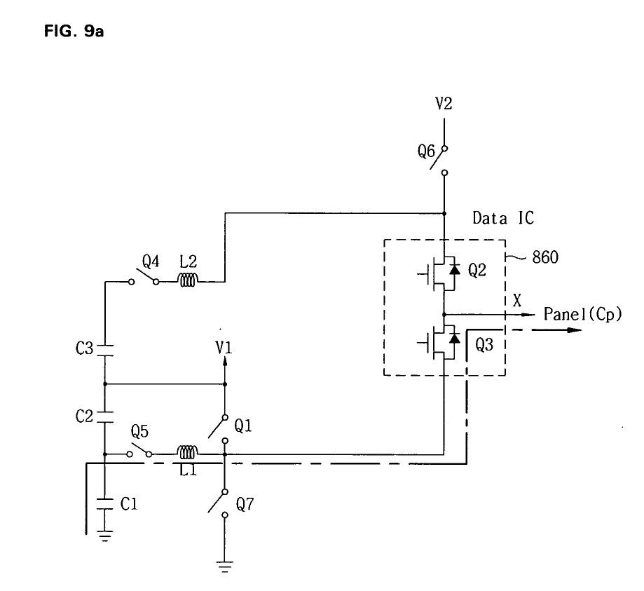

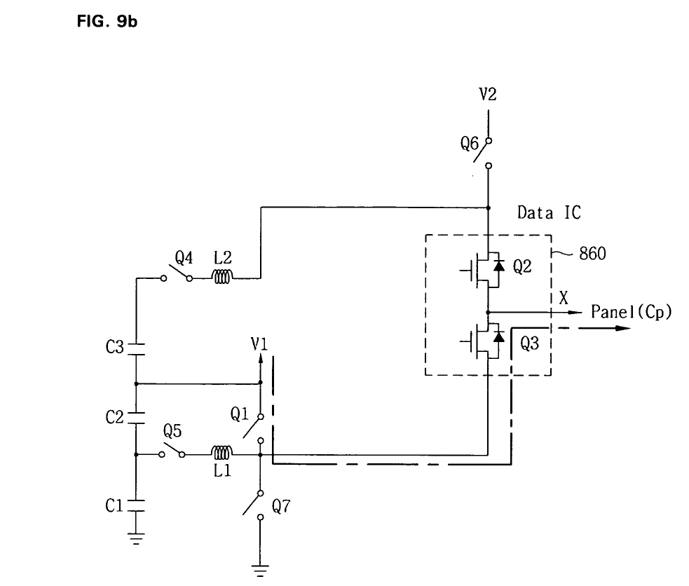

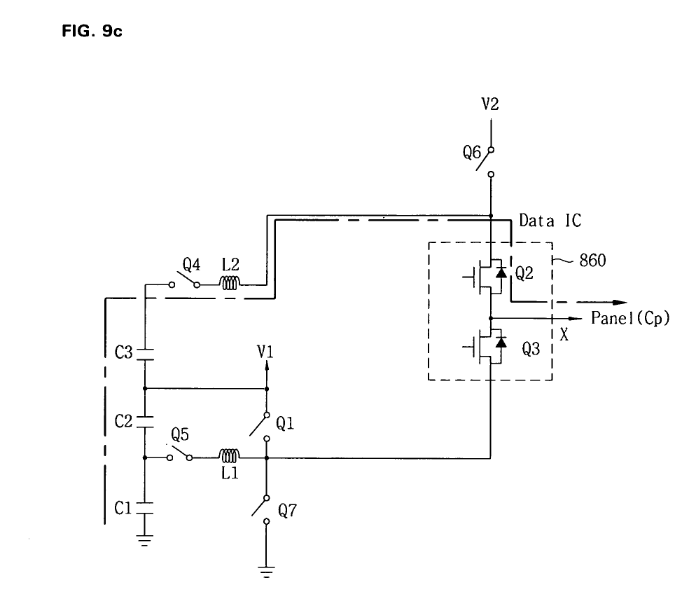

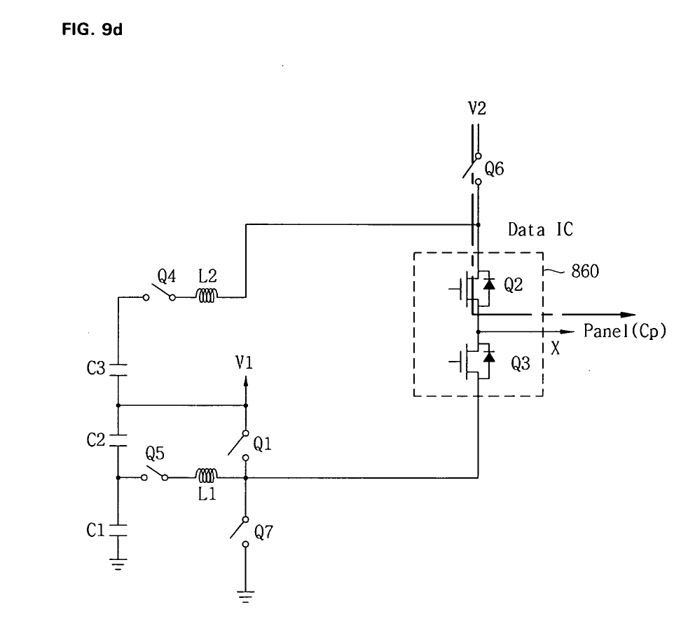

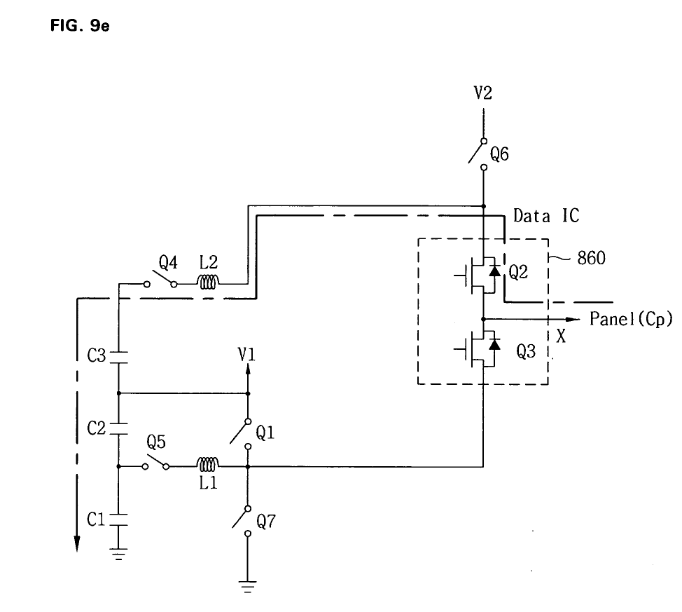

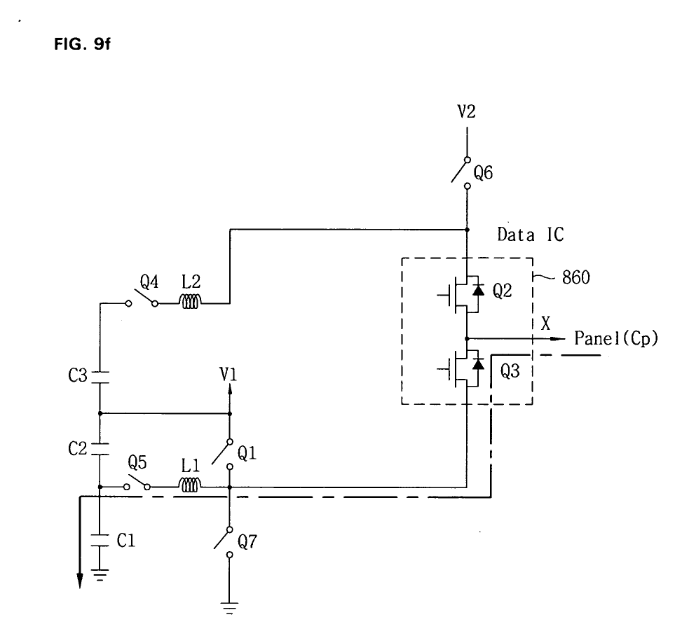

A circuit operation of the data driver of FIG. 8 will be described in detail with reference to FIGS. 9a to 9f.

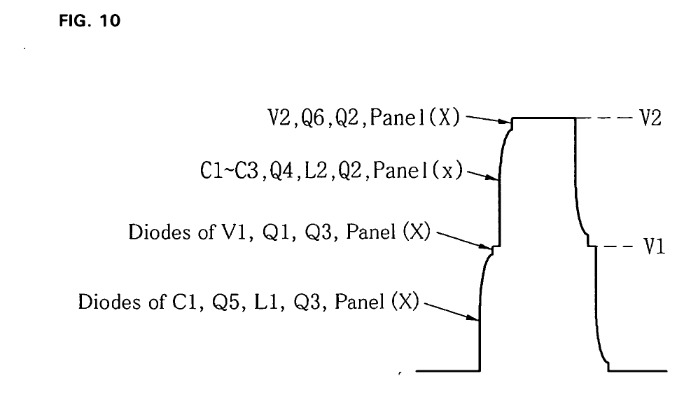

FIGS. 9a to 9f illustrate a circuit operation of the data driver of FIG. 8 in order. FIG. 10 illustrates a data pulse depending on a switching operation of the data driver of FIG. 8.

As illustrated in FIG. 9a, when the fifth switch Q5 is turned on, the reactive energy of the panel stored in the first energy storing unit C1 is supplied to the data electrode through a diode of the third switch Q3 by the resonance between the first inductor L1 and an equivalent capacitor Cp of the plasma display panel. As illustrated in FIG. 10, the voltage of the data pulse rises using the reactive energy of the panel before supplying the first voltage V1, thereby reducing power consumption.

As illustrated in FIG. 9b, when the fifth switch Q5 is turned off and the first switch Q1 is turned on, the first voltage is supplied to the data electrode through the first voltage source and the diode of the third switch Q3 such that the data pulse is maintained at the first voltage level as illustrated in FIG. 10.

As illustrated in FIG. 9c, when the fourth switch Q4 is turned on, the reactive energy of the plasma display panel stored in the first energy storing unit C1, the second energy storing unit C2 and the third energy storing unit C3 is supplied to the data electrode through the second switch Q2 of a turn-on state by the resonance between the second inductor L2 and the equivalent capacitor Cp of the plasma display panel. As illustrated in FIG. 10, the voltage of the data pulse rises using the reactive energy of the panel before supplying the second voltage V2, thereby reducing power consumption.

The energy recovery circuit operates during at least one of a period of time when the data pulse of FIG. 10 rises to the first voltage level V1 or a period of time when the data pulse of FIG. 10 rises from the first voltage level V1 to the second voltage level V2, thereby reducing power consumption. Furthermore, the energy recovery circuit operates during both the period of time when the data pulse of FIG. 10 rises to the first voltage level V1 and the period of time when the data pulse of FIG. 10 rises from the first voltage level V1 to the second voltage level V2, thereby reducing power consumption more efficiently. In other words, the power consumption is reduced, even if one of the first energy supply/recovery circuit 820 and the second energy supply/recovery circuit 840 of FIG. 8 is used.

As illustrated in FIG. 9d, when the fourth switch Q4 is turned off and the sixth switch Q6 is turned on, the second voltage source supplies the second voltage to the data electrode through the second switch Q2 of a turn-on state such that the data pulse of FIG. 10 is maintained at the second voltage level V2.

As illustrated in FIG. 9e, the sixth switch Q6 is turned off and the fourth switch Q6 is turned on, the energy remaining in the plasma display panel is recovered through the diode of the second switch Q2 and the second inductor L2, and the recovered energy is then stored in the first energy storing unit, the second energy storing unit and the third energy storing unit. The waveform of the switching operation in FIG. 9e is the same as the waveform illustrated during a period of time when the data pulse of FIG. 10 falls from the second voltage level V2 to the first voltage level V1.

When the data pulse of FIG. 10 falls from the first voltage level V1 to a voltage lower than the first voltage level V1, as illustrated in FIG. 9f, the fourth switch Q4 is turned off and the third switch Q3 and the fifth switch Q5 are turned on such that the energy remaining in the panel is stored in the first energy storing unit through the third switch Q3, the first inductor L1 and the fifth switch Q5. Afterwards, although it is not illustrated in the attached drawings, the seventh switch Q7 is turned on such that the voltage of the data electrode is maintained at the ground level voltage to complete the supplying of the data pulse.

The driving signal output unit comprising the second switch Q2 and the third switch Q3 connected to each other in a push-pull form controls its circuit operation through the predetermined switching operation of the driving signal output unit, thereby excessively generating a displacement current. Accordingly, the driving signal output unit needs to comprise the elements with a high withstanding current or a high withstanding voltage. However, this results in an increase in the manufacturing cost.

However, in the plasma display apparatus according to the embodiments, the second voltage V2 (i.e., the data voltage) is supplied to one terminal of the second switch Q2 and the first voltage V1 that is higher than the ground level voltage and is lower than the data voltage is supplied to the other terminal of the third switch Q3. Accordingly, a voltage formed between one terminal of the second switch Q2 and the other terminal of the third switch Q3 is equal to a difference (i.e., V2-V1) between the second voltage V2 and the first voltage V1 such that a voltage lower than the related art is formed between one terminal of the second switch Q2 and the other terminal of the third switch Q3. Therefore, a damage to the elements of the data driver decreases, and the data driver may comprise elements with a low withstanding voltage characteristic such that the manufacturing cost decreases.

The low voltage driving of the plasma display apparatus reduces an influence of the high voltage on the circuit. In other words, the low voltage driving of the plasma display apparatus reduces power consumption and minimizes the problems caused by heat generation. Accordingly, a heat-resisting property of the plasma display apparatus can be held without the hest sink, thereby greatly reducing the manufacturing cost of the plasma display apparatus.

In particular, when the first voltage supply unit and the second voltage supply unit are integrated into one voltage supply unit, i.e., when the plasma display apparatus is driven using a voltage source having a voltage equal to one half the highest voltage of the data pulse, the plasma display apparatus is driven at one half the voltage of the related art data pulse. As a result, power consumption is equal to one quarter the related art and a current flowing in the driving signal output unit is equal to one half the related art current such that a damage to the circuit is minimized and the driving characteristic is stabilized. In particular, the low voltage driving of the plasma display apparatus is advantageous to the driving signal output unit that is weak in heat.

The low voltage driving of the plasma display apparatus reduces an influence of the factors affecting the discharge characteristic such as the phosphor on the discharge characteristic such that the low voltage driving prevents the factors affecting the discharge characteristic from being fixed. For example, even if the same number of driving pulses is supplied, the plasma display apparatus is driven at the low voltage such that the factors affecting the discharge characteristic is prevented from being fixed. Accordingly, image sticking is prevented. Further, the plasma display apparatus having the improved image quality is provided.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising a data electrode; and
a driver for raising a voltage of a data pulse supplied to the data electrode during an address period to a sum of a first voltage level higher than a ground level voltage and a second voltage level higher than the first voltage level.

2. The plasma display apparatus of claim 1, wherein the driver supplies the first voltage level higher than the ground level voltage and then supplies the second voltage level higher than the first voltage level to the data electrode during the address period.

3. The plasma display apparatus of claim 2, wherein the driver comprises
a second voltage supply unit for supplying the second voltage to the data electrode,
a voltage supply controller, formed between the second voltage supply unit and the data electrode, for controlling the supplying of the second voltage and the ground level voltage, and
an energy storing unit for dividing the second voltage supplied by the second voltage supply unit and for storing the divided voltage.

4. The plasma display apparatus of claim 3, wherein the driver comprises
a driving signal output unit for outputting a voltage supplied by the second voltage supply unit and a voltage supplied by the energy storing unit to the data electrode through a predetermined switching operation of the driving signal output unit, and
a ground level voltage supply unit, connected to the voltage supply controller and the energy storing unit, for supplying a ground level voltage to the data electrode.

5. The plasma display apparatus of claim 4, wherein the voltage supply controller comprises a first switch and a second switch connected to each other in series,
the energy storing unit comprises a first energy storing unit and a second energy storing unit connected to each other in series,
the second voltage supply unit is commonly connected to one terminal of the first switch, one terminal of the first energy storing unit and one terminal of the driving signal output unit,
the ground level voltage supply unit is commonly connected to the other terminal of the first switch, one terminal of the second switch and the other terminal of the second energy storing unit, and
the other terminal of the driving signal output unit is commonly connected to the other terminal of the second switch, the other terminal of the first energy storing unit and one terminal of the second energy storing unit.

6. The plasma display apparatus of claim 5, wherein when the first switch is turned on, the first voltage is supplied to the data electrode, and the second voltage is then supplied to the data electrode, and
wherein when the second switch is turned on, the ground level voltage is supplied to the data electrode.

7. The plasma display apparatus of claim 6, wherein when the first switch is turned on, the first voltage is supplied to the other terminal of the driving signal output unit and the second voltage is supplied to one terminal of the driving signal output unit.

8. The plasma display apparatus of claim 4, wherein the voltage supply controller comprises a third switch and a fourth switch connected to each other in series,
the energy storing unit comprises a third energy storing unit and a fourth energy storing unit connected to each other in series,
the second voltage supply unit is commonly connected to one terminal of the third energy storing unit and one terminal of the driving signal output unit,
the ground level voltage supply unit is commonly connected to the other terminal of the fourth switch and the other terminal of the fourth energy storing unit, and
the other terminal of the driving signal output unit is commonly connected to the other terminal of the third switch and one terminal of the fourth switch.

9. The plasma display apparatus of claim 8, wherein when the third switch is turned on, the first voltage is supplied to the data electrode, and the second voltage is then supplied to the data electrode, and
wherein when the fourth switch is turned on, the ground level voltage is supplied to the data electrode.

10. The plasma display apparatus of claim 9, wherein when the third switch is turned on, the first voltage is supplied to the other terminal of the driving signal output unit and the second voltage is supplied to one terminal of the driving signal output unit.

11. The plasma display apparatus of claim 2, wherein the driver comprises
a first voltage supply unit for supplying the first voltage to the data electrode,
a second voltage supply unit for supplying the second voltage to the data electrode, and
a voltage supply controller, formed between the first voltage supply unit and the second voltage supply unit, for controlling the supplying of the first voltage, the second voltage and the ground level voltage.

12. The plasma display apparatus of claim 11, wherein the driver comprises
a driving signal output unit for outputting a voltage supplied by the first voltage supply unit and a voltage supplied by the second voltage supply unit to the data electrode through a predetermined switching operation of the driving signal output unit, and
a ground level voltage supply unit, connected to the voltage supply controller, for supplying the ground level voltage to the data electrode.

13. The plasma display apparatus of claim 12, wherein the voltage supply controller comprises a fifth switch, a sixth switch and a seventh switch connected to one another in series,
the second voltage supply unit is commonly connected to one terminal of the fifth switch and one terminal of the driving signal output unit,
the ground level voltage supply unit is commonly connected to the other terminal of the fifth switch and one terminal of the sixth switch,
the other terminal of the driving signal output unit is commonly connected to the other terminal of the sixth switch and one terminal of the seventh switch, and
the first voltage supply unit is connected to the other terminal of the seventh switch.

14. The plasma display apparatus of claim 13, wherein when the fifth switch and the seventh switch are turned on, the first voltage is supplied to the data electrode, and the second voltage is then supplied to the data electrode, and
wherein when the sixth switch is turned on, the ground level voltage is supplied to the data electrode.

15. The plasma display apparatus of claim 14, wherein when the fifth switch and the seventh switch are turned on, the first voltage is supplied to the other terminal of the driving signal output unit, and the second voltage is supplied to one terminal of the driving signal output unit.

16. A plasma display apparatus comprising:
a plasma display panel comprising a data electrode; and
a driver for recovering a reactive energy from the plasma display panel, and for raising a voltage of a data pulse supplied to the data electrode during an address period to a first voltage level and then to a second voltage level higher than the first voltage level stage by stage.

17. The plasma display apparatus of claim 16, wherein the driver comprises
an energy storing unit for storing the reactive energy recovered from the plasma display panel,
a first energy supply/recovery controller for supplying a portion of the energy stored in the energy storing unit to the data electrode through resonance,
a first voltage supply unit for maintaining a voltage of the data electrode at a first voltage level,
a second energy supply/recovery controller for supplying the energy stored in the energy storing unit to the data electrode through resonance during the supplying of the first voltage, and
a second voltage supply unit for maintaining a voltage of the data electrode at a second voltage level during the supplying of the first voltage.

18. The plasma display apparatus of claim 17, wherein the driver comprises
a driving signal output unit for outputting voltages supplied by the first voltage supply unit or the second voltage supply unit to the data electrode through a predetermined switching operation of the driving signal output unit, and
a ground level voltage supply unit for maintaining a voltage of the data electrode at a ground level voltage.

19. The plasma display apparatus of claim 18, wherein the energy storing unit comprises a first energy storing unit, a second energy storing unit, and a third energy storing unit,
the first voltage supply unit comprises a first voltage source and a first switch for controlling the supplying of the first voltage by the first voltage source,
one terminal of the first energy storing unit is commonly connected to one terminal of the first energy supply/recovery controller and the other terminal of the second energy storing unit, and the other terminal of the first energy storing unit is connected to a ground level voltage source,
the other terminal of the first energy supply/recovery controller is commonly connected to the other terminal of the first switch, the other terminal of the ground level voltage supply unit and the other terminal of the driving signal output unit,
one terminal of the first switch is commonly connected to one terminal of the first voltage source, one terminal of the second energy storing unit and the other terminal of the third energy storing unit,
one terminal of the third energy storing unit is connected to one terminal of the second energy supply/recovery controller, and
the other terminal of the second energy supply/recovery controller is commonly connected to the second voltage supply unit and one terminal of the driving signal output unit.

20. The plasma display apparatus of claim 19, wherein when a switch of the first energy supply/recovery controller is turned on, an energy is supplied to the data electrode, and when the first switch of the first voltage supply unit is turned on, the first voltage is supplied to the data electrode, and
wherein when a switch of the second energy supply/recovery controller is turned on, an energy is supplied to the data electrode, and when a switch of the second voltage supply unit is turned on, a voltage of the data electrode is maintained at the second voltage level.

21. The plasma display apparatus of claim 20, wherein the first voltage is supplied to the other terminal of the driving signal output unit, and the second voltage is supplied to one terminal of the driving signal output unit.

22. A method of driving a plasma display apparatus comprising a data electrode, the method comprising:
raising a voltage of a data pulse supplied to the data electrode during an address period to a sum of a first voltage level higher than a ground level voltage and a second voltage level higher than the first voltage level.

23. The method of claim 22, wherein a reactive energy is recovered from the plasma display apparatus such that the data pulse is supplied to the data electrode using the recovered energy.

24. The method of claim 22, further comprising
storing the reactive energy recovered from the plasma display apparatus,
supplying an energy stored in an energy storing unit to the data electrode through resonance during the address period to raise a voltage of the data electrode to a first voltage level,
maintaining a voltage of the data electrode at the first voltage level during the address period,
supplying the energy stored in the energy storing unit to the data electrode through resonance during the supplying of the first voltage in the address period to raise a voltage of the data electrode to a second voltage level, and
maintaining a voltage of the data electrode at the second voltage level during the supplying of the first voltage in the address period.
